(19) United States
(12) Patent Application Publication
(10) Pub. No.: US 2016/0102497 A1
(43) Pub. Date: Apr. 14, 2016

(54) Ladder Stabilizer

(71) Applicant: Jerald J. Riopel, Livingston, TX (US)

(72) Inventor: Jerald J. Riopel, Livingston, TX (US)

(21) Appl. No.: 14/511,429

(22) Filed: Oct. 10, 2014

(51) Int. Cl. E06C 7/42

(52) U.S. Cl. CPC E06C 7/423

(57) ABSTRACT

A ladder stabilizer for safely and efficiently stabilizing a ladder against a surface. The ladder stabilizer generally includes a base having a pair of angularly-disposed support brackets positioned on its front end. Each of the support brackets includes a tubular support receiver having a support opening adapted to receive a corresponding support. Each of the supports generally comprises angled L-shaped structures. Connector bolts aid in securing the base to a ladder rung. Pin receivers on each of the support receivers allow the use of pop pins to selectively lock the supports between a first retracted position for transport and a second extended position for usage.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a ladder aid and more specifically it relates to a ladder stabilizer for safely and efficiently stabilizing a ladder against a surface.

2. Description of the Related Art

Any discussion of the related art throughout the specification should in no way be considered as an admission that such related art is widely known or forms part of common general knowledge in the field.

While ladders are commonly used throughout the world for a wide variety of projects, there remains a large incidence of injuries which have occurred due to insufficient ladder stabilization. When on a ladder, particularly at a great height, stability is paramount to safety. Even a slight rocking on an unstabilized ladder can lead to injury or death.

Because of the inherent problems with the related art, there is a need for a new and improved ladder stabilizer for safely and efficiently stabilizing a ladder against a surface.

### BRIEF SUMMARY OF THE INVENTION

The invention generally relates to a ladder stabilizer which includes a base having a pair of angularly-disposed support brackets positioned on its front end. Each of the support brackets includes a tubular support receiver having a support opening adapted to receive a corresponding support. Each of the supports generally comprise angled L-shaped structures. Connector bolts aid in securing the base to a ladder rung. Pin receivers on each of the support receivers allow the use of pop pins to selectively lock the supports between a first retracted position for transport and a second extended position for usage.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention in alignment for installation on a ladder.

FIG. 2 is an upper perspective view of the present invention installed on a ladder with the stabilizers in a retracted position.

FIG. 3 is an upper perspective view of the present invention installed on a ladder with the stabilizers in an extended position.

FIG. 4 is an upper perspective view of the present invention with the stabilizers in a retracted position.

FIG. 5 is an upper perspective view of the present invention with the stabilizers in an extended position.

FIG. 6 is a frontal view of the present invention.

FIG. 7 is a rear view of the present invention.

FIG. 8 is a side view of the present invention with the stabilizers in a retracted position.

FIG. 9 is a side view of the present invention with the stabilizers in an extended position.

FIG. 10 is a side view of the present invention in use.

### DETAILED DESCRIPTION OF THE INVENTION

### A. Overview.

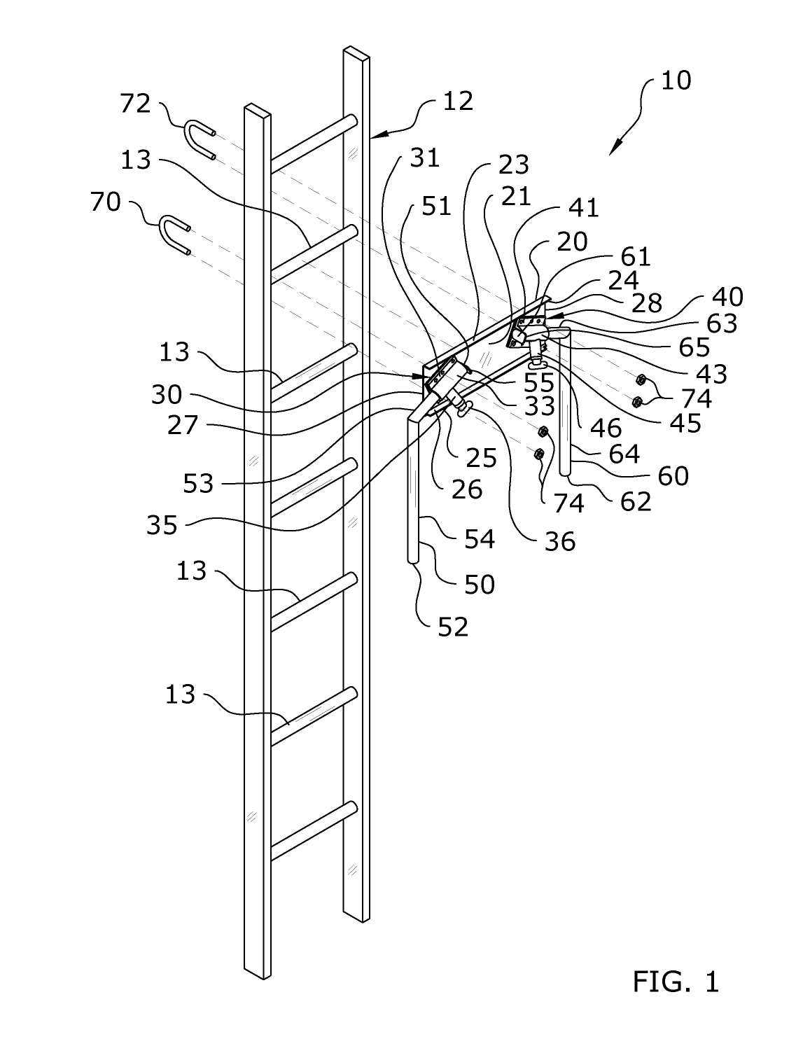

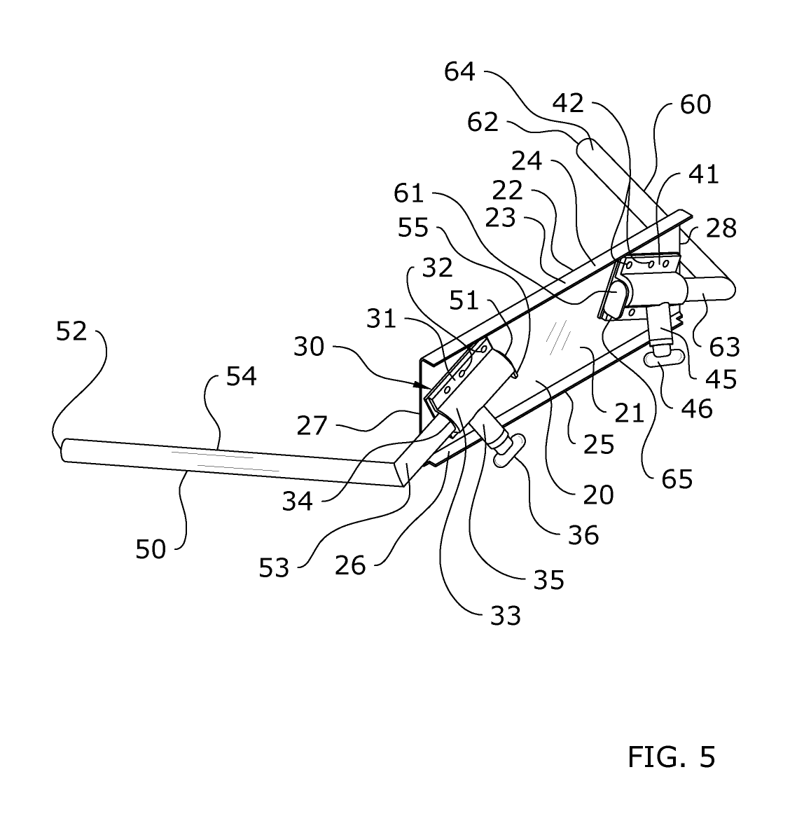

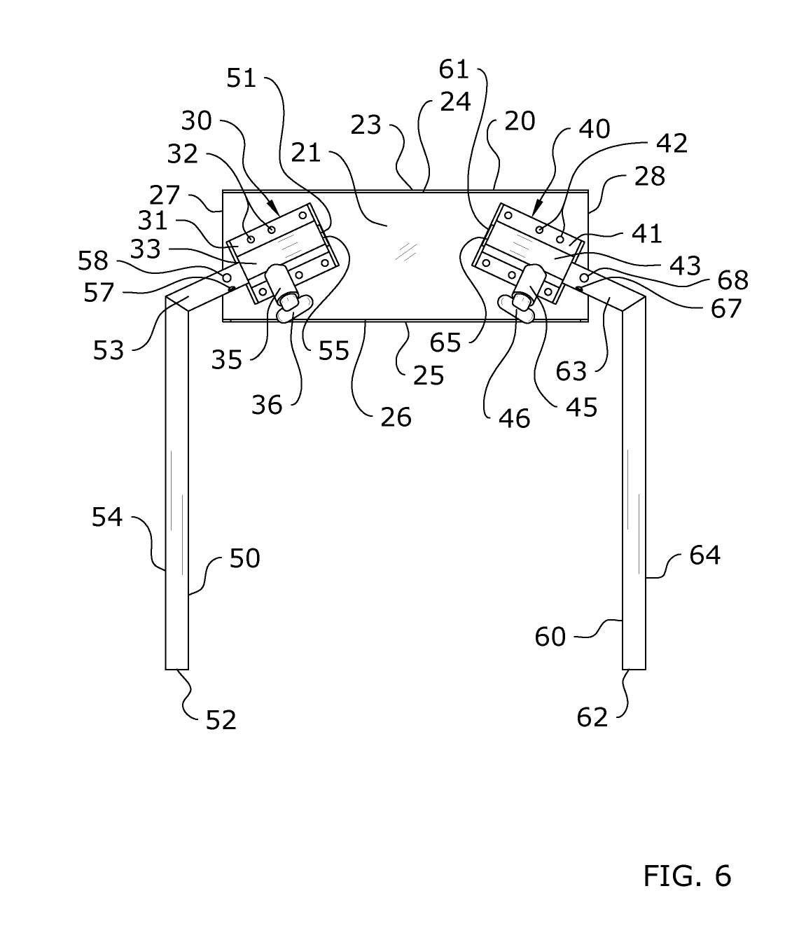

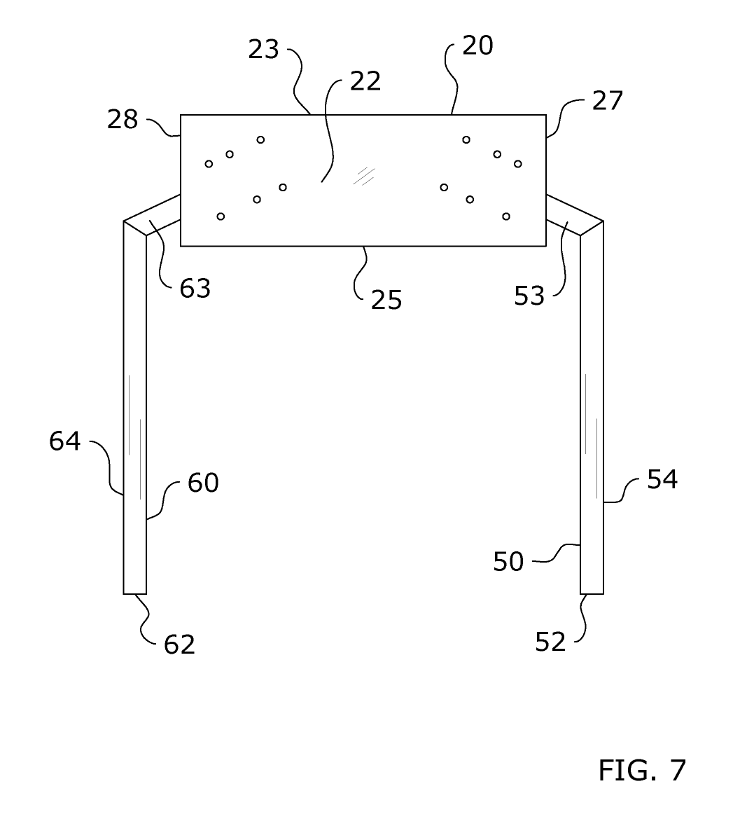

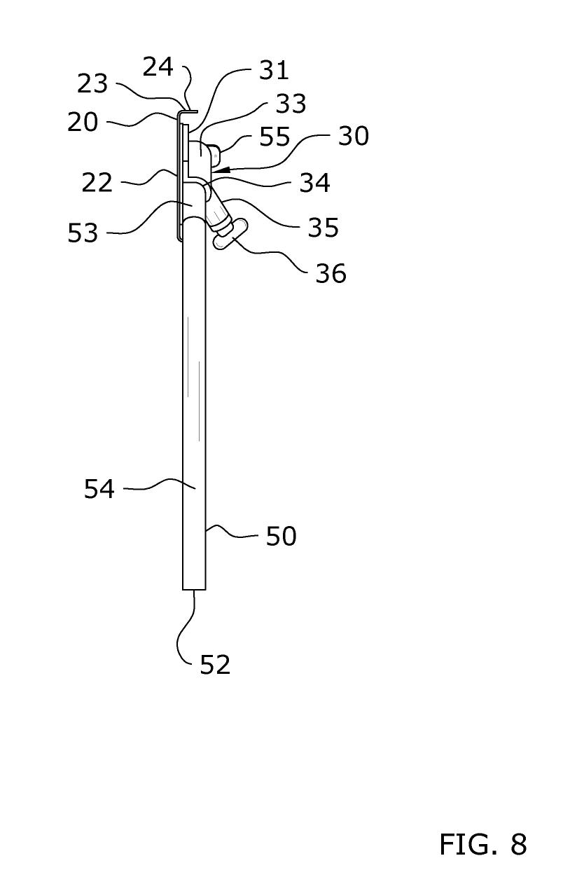

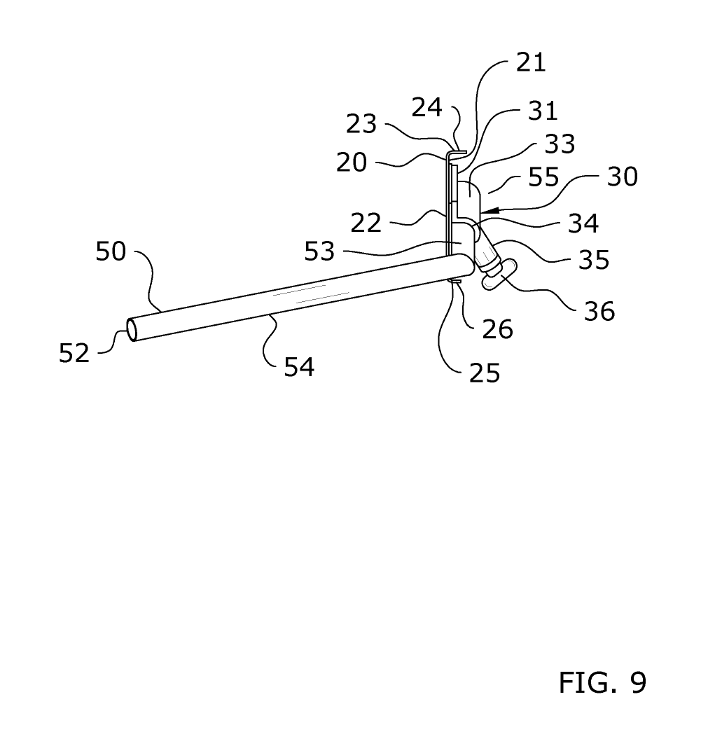

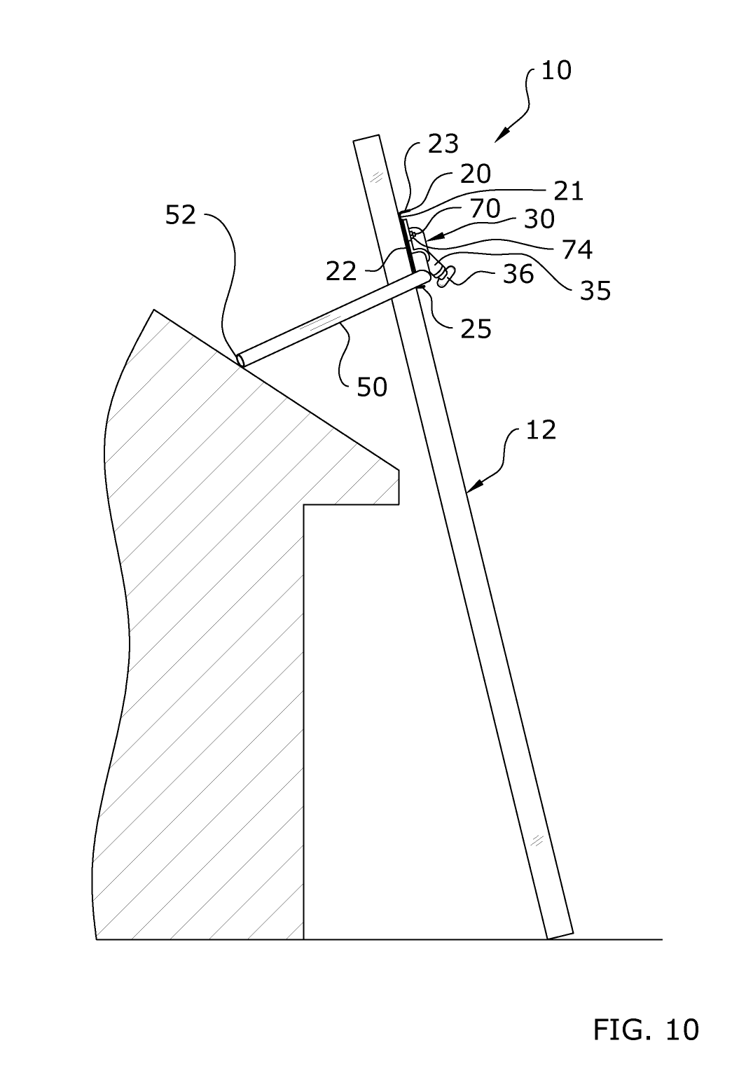

Turning now descriptively to the drawings, in which similar reference characters denote similar elements throughout the several views, FIGS. 1 through 10 illustrate a ladder stabilizer 10, which comprises a base 20 having a pair of angularly-disposed support brackets 30, 40 positioned on its front end 21. Each of the support brackets 30, 40 includes a tubular support receiver 33, 43 having a support opening 34, 44 adapted to receive a corresponding support 50, 60. Each of the supports 50, 60 generally comprise angled L-shaped structures. Connector bolts 70, 72 aid in securing the base 20 to a ladder rung 13. Pin receivers 35, 45 on each of the support receivers 33, 43 allow the use of pop pins 36, 46 to selectively lock the supports 50, 60 between a first refracted position for transport and a second extended position for usage.

### B. Base.

As shown throughout the figures, the present invention includes a base 20 which is adapted to be removably secured to a ladder 12 and from which extends the adjustable supports 50, 60 of the present invention. The shape, size, and configuration of the base 20 may vary in different embodiments of the present invention to suit different ladder 12 types.

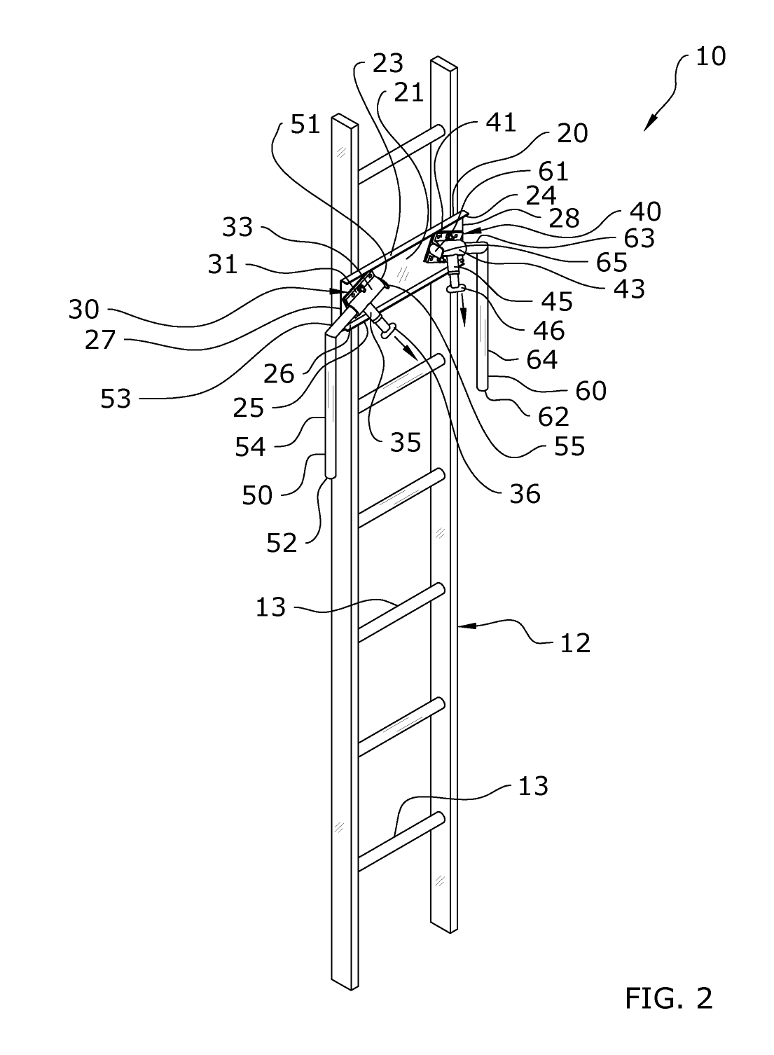

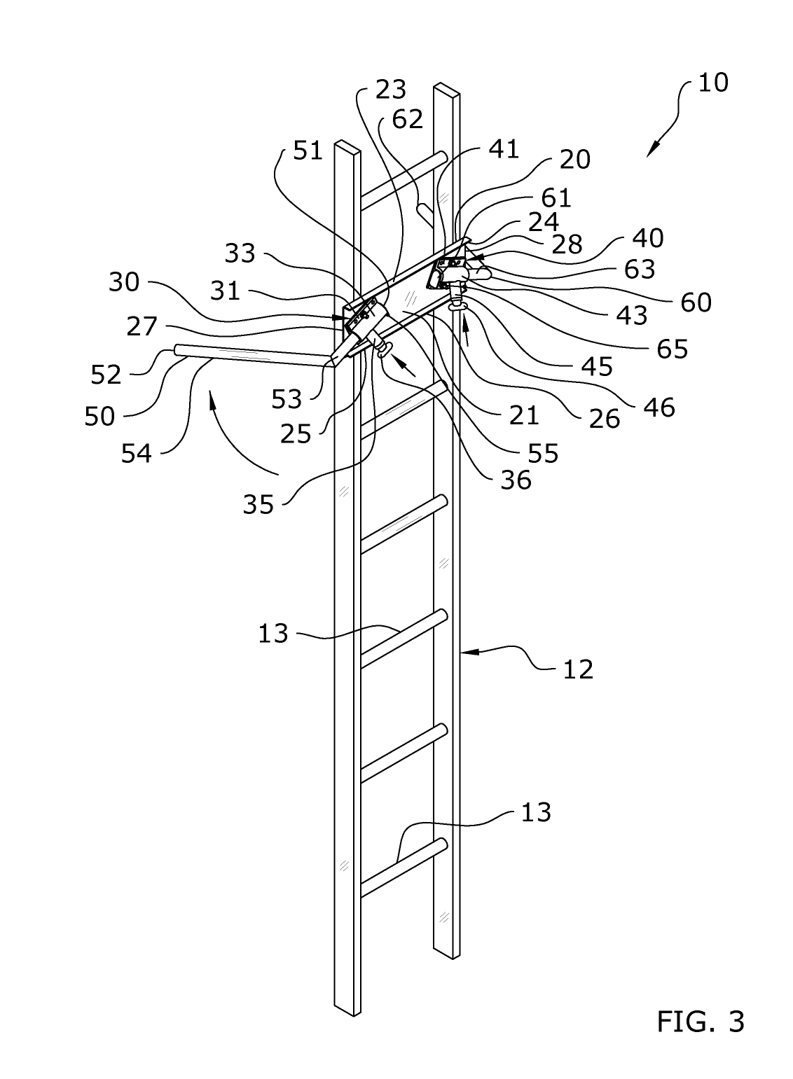

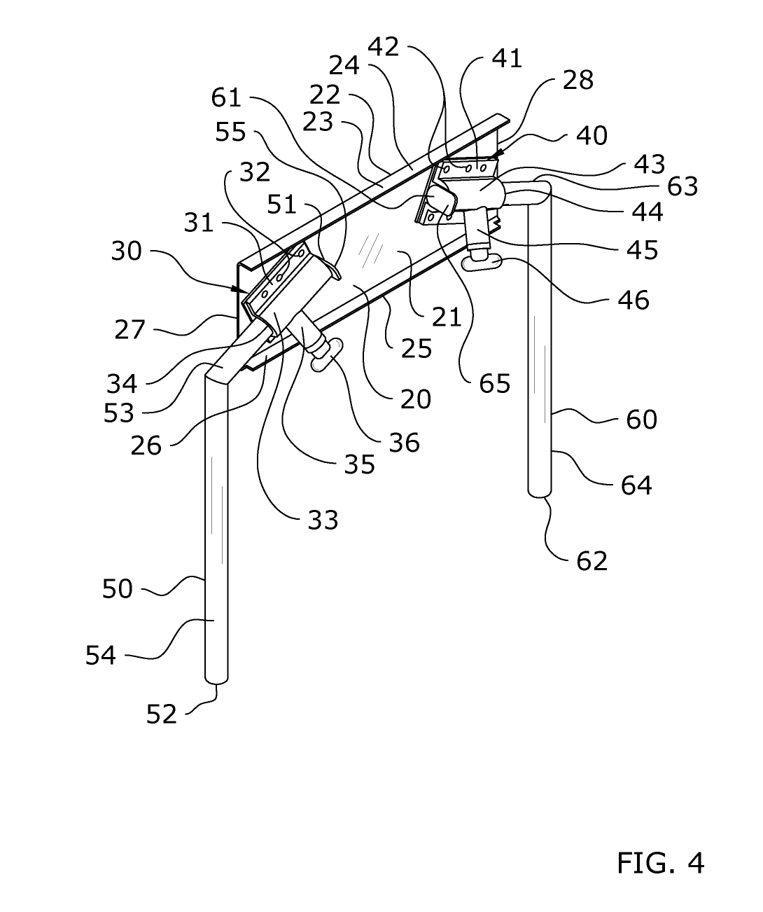

The base 20 includes a front end 21 having a pair of support brackets 30, 40 and a rear end 22 which rests against the ladder 12 when the present invention is installed thereon as shown in FIGS. 2 and 3. The upper end 23 of the base 20 includes an upper flange 24 and the lower end 25 of the base 20 includes a lower flange 26 as best shown in FIG. 4. The base 20 also includes a first side 27 and a second side 28, with the first support bracket 30 being adjacent to the first side 27 of the base 20 and the second support bracket 40 being adjacent to the second side 28 of the base 20.

### C. Support Brackets.

As shown throughout the figures, the base 20 includes a pair of support brackets 30, 40 secured to its front end 21. Each of the support brackets 30, 40 extends at an opposite angle with respect to the other as best shown in FIG. 4. The numbering, size, positioning, and configuration of the support brackets 30, 40 may vary in different embodiments and thus should not be construed as limited by the exemplary figures included herein.

In a preferred embodiment as shown in the figures, a first support bracket 30 is secured adjacent to the first side 27 of the front end 21 of the base 20 and a second support bracket 40 is secured adjacent to the second side 28 of the base 20. The first support bracket 30 is angled upwardly in the direction of the first side 27 and the second support bracket 40 is angled upwardly in the direction of the second side 28.

In a preferred embodiment, the first support bracket 30 includes a first base 31 which is fixedly or removably secured to the front end 21 of the base 20 adjacent to its first side 27. The first base 31 may include a plurality of first mount openings 32 which extend through both the first support bracket 30 and the base 20 such that the first connector bolt 70 may be extended through the first mount openings 32 to secure the base 20 to a ladder 12.

As shown in FIG. 4, a tubular first support receiver 33 extends outwardly from the first base 31. The first support receiver 33 generally comprises a tubular structure extending from or integrally formed with the first base 31. A first support opening 34 extends through the first support receiver 33 which is adapted to receive the first support 50 of the present invention.

The first support bracket 30 utilizes a push-pin configuration to lock the first support 50 into its various positions. Thus, the first support bracket 30 includes a first pin receiver 35 which extends perpendicularly with respect to the first support receiver 33. A first pin 36, preferably comprised of a spring-loaded pop pin, is inserted within the first pin receiver 35. As the first pin 36 is extended within the first pin receiver 35, the first pin 36 will enter the first support opening 34 to engage with a corresponding aperture 57, 58 in the first support 50 to lock the first support 50 into position.

In a preferred embodiment, the second support bracket 40 includes a second base 41 which is fixedly or removably secured to the front end 21 of the base 20 adjacent to its second side 28. The second base 41 may include a plurality of second mount openings 42 which extend through both the second support bracket 40 and the base 20 such that the second connector bolt 72 may be extended through the second mount openings 42 to secure the base 20 to a ladder 12.

As shown in FIG. 4, a tubular second support receiver 43 extends outwardly from the second base 41. The second support receiver 43 generally comprises a tubular structure extending from or integrally formed with the second base 41. A second support opening 44 extends through the second support receiver 43 which is adapted to receive the second support 60 of the present invention.

The second support bracket 40 utilizes a push-pin configuration to lock the second support 60 into its various positions. Thus, the second support bracket 40 includes a second pin receiver 45 which extends perpendicularly with respect to the second support receiver 43. A second pin 46, preferably comprised of a spring-loaded pop pin, is inserted within the second pin receiver 45. As the second pin 46 is extended within the second pin receiver 45, the second pin 46 will enter the second support opening 44 to engage with a corresponding aperture 67, 68 in the second support 60 to lock the second support 60 into position.

### D. Supports.

As shown throughout the figures, the present invention utilizes supports 50, 60 to stabilize the ladder 12 against a structure. Generally, a first support 50 will be rotatably secured within the first support bracket 30 and a second support 60 will be rotatably secured within the second support bracket 40.

The first support 50 comprises an angled L-shaped structure having a first end 51 and a second end 52. The first end 51 of the first support 50 is positioned within the first support bracket 30 and the second end 52 of the first support 50 acts as a stabilizer against the structure.

As shown throughout the figures, the L-shaped structure of the first support 50 is created by having a first portion 53 extending at an angle with respect to a second portion 54 of the first support 50. The angle between the first and second portions 53, 54 may vary in different embodiments and thus should not be construed as limited by the exemplary figures.

The first end 51 of the first support 50 may include a first flange 55 as best shown in FIG. 4. The first flange 55 limits full rotation of the first support 50 by contacting the front end 21 of the base 20 when the first support 50 is rotated too far in either direction. The structure, shape, and configuration of the first flange 55 may vary in different embodiments of the present invention.

The first portion 53 of the first support 50 may include a pair of apertures 57, 58 through which the first pin 36 of the present invention will extend to lock the first support 50 between its positions. In a preferred embodiment, the first portion 53 of the first support 50 includes a first retracted aperture 57 which locks the first support 50 in a refracted position and a first extended aperture 58 which locks the first support 50 in an extended position. The first refracted aperture 57 thus extends perpendicularly with respect to the first extended aperture 58 as shown in the figures.

The second support 60 comprises an angled L-shaped structure having a first end 61 and a second end 62. The first end 61 of the second support 60 is positioned within the second support bracket 40 and the second end 62 of the second support 60 acts as a stabilizer against the structure.

As shown throughout the figures, the L-shaped structure of the second support 60 is created by having a first portion 63 extending at an angle with respect to a second portion 64 of the second support 60. The angle between the first and second portions 63, 64 may vary in different embodiments and thus should not be construed as limited by the exemplary figures.

The first end 61 of the second support 60 may include a second flange 65 as best shown in FIG. 4. The second flange 65 limits fill rotation of the second support 60 by contacting the front end 21 of the base 20 when the second support 60 is rotated too far in either direction. The structure, shape, and configuration of the second flange 65 may vary in different embodiments of the present invention.

The first portion 63 of the second support 60 may include a pair of apertures 67, 68 through which the second pin 46 of the present invention will extend to lock the second support 60 between its positions. In a preferred embodiment, the first portion 63 of the second support 60 includes a second retracted aperture 67 which locks the second support 60 in a refracted position and a second extended aperture 68 which locks the second support 60 in an extended position. The second refracted aperture 67 thus extends perpendicularly with respect to the second extended aperture 68 as shown in the figures.

### E. Connector Bolts.

As best shown in FIG. 1, a pair of connector bolts 70, 72 secure the present invention to a ladder 10. In a preferred embodiment, a first connector bolt 70 secures the first side 27 of the base 20 to a first side of a ladder rung 13 and a second connector bolt 72 secures the second side 28 of the base 20 to a second side of a ladder run 13.

Each of the connector bolts 70, 72 may comprise different sizes and configurations. In a preferred embodiment, each of the connector bolts 70, 72 comprise U-shaped bolts which are adapted to extend through the mount openings 32, 52 of the brackets 30, 40 and base 20. Nuts 74 are secured to the ends of the connector bolts 70, 72 to anchor them against the ladder run 13.

### F. Operation of Preferred Embodiment.

In use, the first support 50 is inserted within the first support receiver 33 and the second support 60 is inserted within the second support receiver 43. The pop pins 36, 46 are inserted through the refracted apertures 57 of the supports 50, 60 to lock the supports 50, 60 within the refracted position.

When desired, the base 20 may be secured to a ladder rung 13. The base 20 is positioned against the desired ladder rung 13 of a ladder 12 and the connector bolts 70, 72 are inserted through the base 20 and support brackets 30, 40 before being anchored with nuts 74. Thus, the present invention may be secured against a ladder 12 at various locations along its length by selecting an appropriate ladder rung 13.

The supports 50, 60 may now be extended and the ladder 12 placed against the surface. The pop pins 36, 46 are pulled outwardly to disengage with the supports 50, 60. The supports 50, 60 may then be rotated to an extended position and the pop pins 36, 46 re-engaged through the extended apertures 58, 68. With the pop pins 36, 46 so extended, the supports 50, 60 will extend outwardly to act as a support for the ladder 13. When finished, the supports 50, 60 may be refracted to their resting position for ease-of-transport of the ladder 12.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

1. A ladder stabilizer, comprising:
a base;
a first support bracket angularly positioned adjacent to a first side of said base;
a second support bracket angularly positioned adjacent to a second side of said base;
a first support rotatably positioned within said first support bracket; and
a second support rotatably positioned within said second support bracket, wherein said first support and said second support are each rotatably adjustable between a vertical resting position and a horizontal extended position.

2. The ladder stabilizer of claim 1, further comprising one or more connector bolts for securing said base against a ladder rung.

3. The ladder stabilizer of claim 2, wherein said one or more connector bolts each comprise a U-shaped bolt.

4. The ladder stabilizer of claim 1, wherein said first support includes a first portion and a second portion extending at an angle with respect to said first portion.

5. The ladder stabilizer of claim 4, wherein said second support includes a first portion and a second portion extending at an angle with respect to said first portion.

6. The ladder stabilizer of claim 1, wherein said first support bracket includes a tubular first support receiver and wherein said second support bracket includes a tubular second support receiver.

7. The ladder stabilizer of claim 6, further comprising a first pin receiver extending from said first support receiver and a second pin receiver extending from said second support receiver.

8. The ladder stabilizer of claim 7, further comprising a first pin secured within said first pin receiver for locking said first support between a plurality of positions.

9. The ladder stabilizer of claim 8, further comprising a second pin secured within said second pin receiver for locking said second support between a plurality of positions.

10. The ladder stabilizer of claim 9, wherein said first pin and said second pin are each comprised of a pop pin.
